(19) United States
(12) Patent Application Publication
(10) Pub. No.: US 2023/0054589 A1
(43) Pub. Date: Feb. 23, 2023

(54) WEARABLE ELECTRIC-CIRCUIT-INTEGRATED MOLDED ARTICLE

(71) Applicant: NISSHA CO.,LTD., Kyoto (JP)

(72) Inventors: Chuzo TANIGUCHI, Kyoto (JP); Ryomei OMOTE, Kyoto (JP); Eiji KAWASHIMA, Kyoto (JP); Jun SASAKI, Kyoto (JP); Yoshihiro SAKATA, Kyoto (JP); Toshitsugu FUJIMURA, Kyoto (JP)

(73) Assignee: NISSHA CO.,LTD., Kyoto (JP)

(21) Appl. No.: 17/793,922

(22) PCT Filed: Jan. 27, 2021
(86) PCT No.: PCT/JP2021/002825

§ 371 Date: Jul. 19, 2022

(30) Foreign Application Priority Data
Mar. 3, 2020 (JP) 2020-035951

(51) Int. Cl. G02C 11/00

(52) U.S. Cl. CPC G02C 11/10; H04R 1/1008

(57) ABSTRACT

A molded body is molded into a prescribed three-dimensional shape. A protective film covers at least a portion of a surface of the molded body. A circuit film is integrally molded with the molded body. An electric circuit is installed in the circuit film and causes a physical change outside of a molded article or causes an electric signal to be generated in accordance with a physical change outside of the molded article. The protective film or the circuit film has a contact area disposed on the surface of a contact portion. The molded body includes a hot melt adhesive: which is disposed on the surface of the molded body which is opposite skin, with the contact area therebetween; and which defines a three-dimensional shape of the contact area within the prescribed shape. The hot melt adhesive covers at least a portion of the circuit film.

### TECHNICAL FIELD

The present invention relates to a wearable electric-circuit-integrated molded article having a contact portion that comes into direct contact with skin of a human body when mounted on the human body.

### BACKGROUND ART

In recent years, development of electric devices that are attached to a human body when used is being actively performed. For example, Patent Literature 1 discloses a spectacle type wireless device in which a wireless device is incorporated in spectacles.

### CITATION LIST

### Patent Literature

[Patent Literature 1]

Japanese Patent Laid-Open No. 2015-233228

### SUMMARY OF INVENTION

### Technical Problem

In order to manufacture a wearable electric device as in the spectacle type wireless device described in Patent Literature 1, it may be necessary to incorporate the electric device in a very small housing. In addition, since it is mounted on a human body, limitations on weight are also applied to the wearable electric device. It is needless to say that a molded article for forming such a wearable electric device is required to be suitable for mass production, but it is also required to have resistance to secretions such as sweat and sebum generated from the human body.

An objective of the present invention is to provide a wearable electric-circuit-integrated molded article that is suitable for mass production, has high waterproofness, and is compact and lightweight.

### Solution to Problem

Hereinafter, a plurality of aspects will be described as means for solving the problems. These aspects can be arbitrarily combined as needed.

A wearable electric-circuit-integrated molded article according to one aspect of the present invention is a wearable electric-circuit-integrated molded article including a contact portion that comes into direct contact with skin of a human body and includes a molded body, a protective film, at least one of a circuit film and a molded circuit component, and an electric circuit. The molded body is molded into a prescribed three-dimensional shape. The protective film covers at least a part of a surface of the molded article. At least one of the circuit film and the molded circuit component is integrally molded with the molded body and includes a conductive layer. The electric circuit is provided in the conductive layer and causes a physical change outside the molded article or generates an electric signal in accordance with a physical change outside the molded article. At least one of the protective film and the circuit film includes a contact area disposed on the entire surface of the contact portion. The molded body includes a hot melt adhesive which is disposed on a surface of the molded body on a side opposite to the skin with the contact area interposed therebetween and defines a three-dimensional shape of the contact area in the prescribed shape. The hot melt adhesive covers at least a part of at least one of the circuit film and molded circuit component.

The wearable electric-circuit-integrated molded article having such a configuration covers at least a part of at least one of the circuit film and the molded circuit component with the hot melt adhesive having the three-dimensional shape, and thus it can improve waterproofness of a wiring of at least one of the circuit film and the molded circuit component. In addition, a precise three-dimensional shape can be formed by using the hot melt adhesive. The contact area of the molded article in which the hot melt adhesive is exposed on the surface from the molded article and faces the skin is covered with one contact area of at least one of the protective film and the circuit film, and thus the hot melt adhesive can be prevented from coming into contact with the skin.

The wearable electric-circuit-integrated molded article described above may be configured such that only the protective film has the contact area. In the electric-circuit-integrated molded article configured as described above, even if the portion of the contact area has a fine three-dimensional shape, the protective film can sufficiently cope with such a fine three-dimensional shape.

The wearable electric-circuit-integrated molded article described above may include an integrated circuit mounted on the circuit film, the electric circuit may include at least one device of an antenna, an LED, a heater and a touch sensor, which is connected to the integrated circuit, the circuit film may be formed on a surface of the hot melt adhesive to have a U-shaped cross-section, a J-shaped cross-section, or an L-shaped cross-section, and the integrated circuit and the device may be configured to be disposed at other locations on the circuit film with the U-shaped cross-section, J-shaped cross-section or L-shaped cross-section on a different surface of the molded body and covered with the hot melt adhesive. In the electric-circuit-integrated molded article configured in this way, in a case in which a surface other than the surface on which the integrated circuit is disposed is at a suitable position for the device, the device can be disposed at the suitable position.

The hot melt adhesive of the wearable electric-circuit-integrated molded article described above may be made of a material that can be injection-molded in a low temperature and low pressure condition of an injection pressure of 0.2 to 6 MPa and an injection temperature of 180° C. or higher and 240° C. or lower. The electric-circuit-integrated molded article configured in this way can reduce damage caused by the hot melt adhesive to, for example, the integrated circuit connected to the electric circuit.

The wearable electric-circuit-integrated molded article described above may be configured such that at least one of the protective film and the circuit film covers all the exposed portions of the hot melt adhesive in the molded body. In the electric-circuit-integrated molded article configured as described above, at least one of the protective film and the circuit film covers all the portions from which the hot melt adhesive is exposed, and thus the hot melt adhesive is not exposed. For this reason, it is possible to prevent the hot melt adhesive from coming into contact with the human body in the case of handling the molded article, and to prevent problems caused by the hot melt adhesive coming into contact with the human body.

### Advantageous Effects of Invention

The wearable electric-circuit-integrated molded article according to the present invention is highly waterproof, compact, lightweight, and suitable for mass production.

### BRIEF DESCRIPTION OF DRAWINGS

FIG. 1 is a perspective view of spectacles to which an electric-circuit-integrated molded article of a first embodiment is applied.

FIG. 2 is a cross-sectional view of a temple along line I-I in FIG. 1.

FIG. 3 is a partially enlarged cross-sectional view showing an antenna of an electric circuit and an integrated circuit.

FIG. 4 is a cross-sectional view of a tip along line II-II in FIG. 1.

FIG. 5 is a perspective view showing a flexible circuit board connected to a circuit film.

FIG. 6 is a cross-sectional view showing an example of a configuration of the circuit film.

FIG. 7 is a cross-sectional view of a temple for explaining a film-integrated molded article of a fourth modified example.

FIG. 8 is a cross-sectional view of a temple for explaining an example of a film-integrated molded article of a fifth modified example.

FIG. 9 is a cross-sectional view of a temple for explaining another example of the film-integrated molded article of the fifth modified example.

FIG. 10 is a cross-sectional view of a temple for explaining yet another example of the film-integrated molded article of the fifth modified example.

FIG. 11 is a cross-sectional view of a temple for explaining an example of a film-integrated molded article of a sixth modified example.

FIG. 12 is a cross-sectional view of a temple for explaining an example of a film-integrated molded article of a seventh modified example.

FIG. 13 is a conceptual diagram showing a usage state of a waterproof music player including an electric-circuit-integrated molded article of a second embodiment.

FIG. 14 is a partially enlarged front view showing a body portion, which is the electric-circuit-integrated molded article.

FIG. 15 is a cross-sectional view of the body portion along line III-III in FIG. 14.

FIG. 16 is a cross-sectional view of the body portion along line IV-IV in FIG. 14

FIG. 17 is a cross-sectional view of the body portion along line V-V in FIG. 14.

FIG. 18 is a partially enlarged front view of the body portion for explaining an antenna.

### DESCRIPTION OF EMBODIMENTS

### First Embodiment

### (1) OVERALL CONFIGURATION

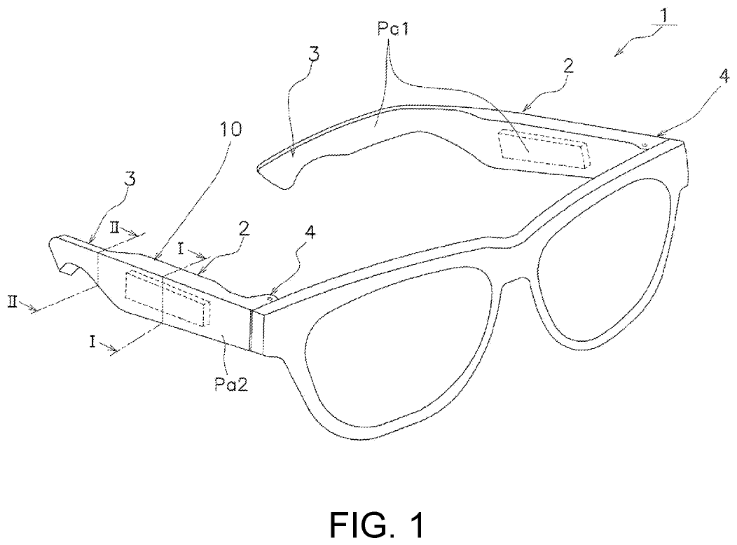

FIG. 1 shows spectacles to which a wearable electric-circuit-integrated molded article according to a first embodiment of the present invention is applied. In spectacles 1 shown in FIG. 1, parts of tips 3 that hang on ears, temples 2, and hinges 4 serve as a wearable electric-circuit-integrated molded article 10 (hereinafter, it may be simply called a molded article 10). Here, there is a contact portion Pa1, which comes into direct contact with skin of a human body, on inner surfaces of the tip 3 and the temple 2 that face a head portion of a user. Portions on surfaces of the tip 3 and the temple 2 other than the contact portion Pa1 are portions that the user can touch by hand, for example, at the time of putting on or taking off the spectacles 1. However, since such a portion is not a location that is always in contact with the skin, the portions other than the contact portion Pa1 that the user can touch by hand at locations of the tip 3, the temple 2, and the hinge 4 are referred to as a quasi-contact portion Pa2.

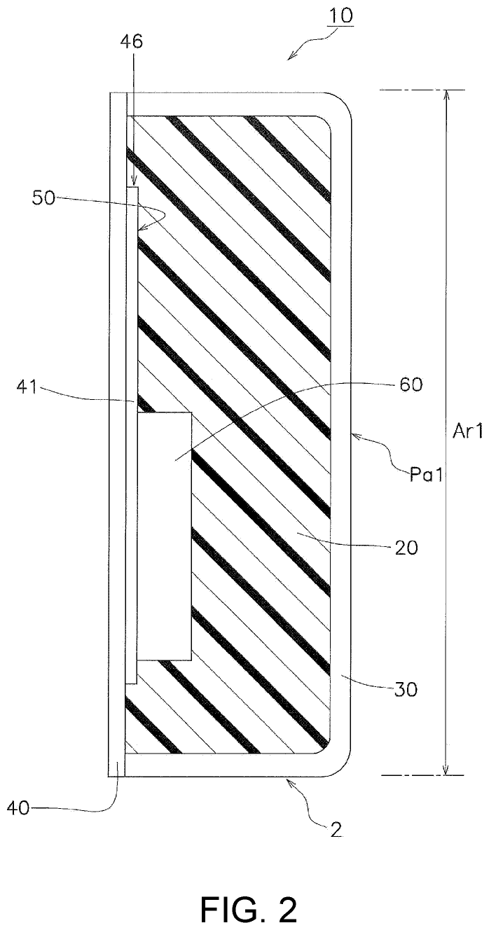

FIG. 2 shows a cross-section of the molded article 10 cut at the location shown by line I-I in FIG. 1. A three-dimensional shape of the molded article 10 is mainly formed by a molded body 20. For that reason, the molded body 20 is molded into a prescribed three-dimensional shape. In the first embodiment, a case in which the molded body 20 is made only of a hot melt adhesive will be described. For example, in a case in which an electric component such as an integrated circuit 60 is mounted inside the molded article 10, by using the hot melt adhesive, a thickness of the thinnest portion of the molded article 10 can be reduced to, for example, about 0.4 mm.

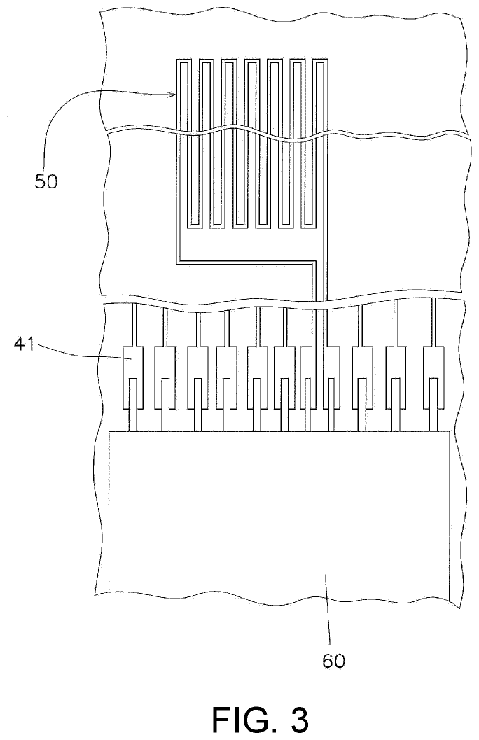

As shown in FIG. 2, a protective film 30 covers a part of a surface of the molded body 20. In addition, as shown in FIG. 2, a circuit film 40 is integrally molded with the molded body 20. The circuit film 40 has a conductive layer 46. An electric circuit 50 is formed in the conductive layer 46 of the circuit film 40. In the first embodiment, the electric circuit 50 includes an antenna shown in FIG. 3. The electric circuit 50 that functions as the antenna causes a physical change such as generation of electromagnetic waves outside the molded article 10. Further, the electric circuit 50 that functions as the antenna receives electromagnetic waves (a physical change) generated outside the molded article 10 and generates an electric signal.

In the first embodiment, in the portion of the temple 2, the protective film 30 has a contact area Ar1 disposed on the entire surface of the contact portion Pa1. The molded body 20 in the portion of the temple 2 is the hot melt adhesive disposed on a side opposite to the skin with the contact area Ar1 of the protective film 30 interposed therebetween. The hot melt adhesive constituting the molded body 20 has a three-dimensional shape having a substantially rectangular cross-section. The shape of the hot melt adhesive (molded body 20) shown in FIG. 2 defines a three-dimensional shape (a substantially rectangular parallelepiped shape) of the temple 2. Here, the fact that the hot melt adhesive defines the three-dimensional shape means that the hot melt adhesive is not used by being applied in thin layers (not flat) and the hot melt adhesive has a three-dimensional shape (a shape surrounded by several planes and/or curved surfaces and occupying a three-dimensional space) other than a layered shape.

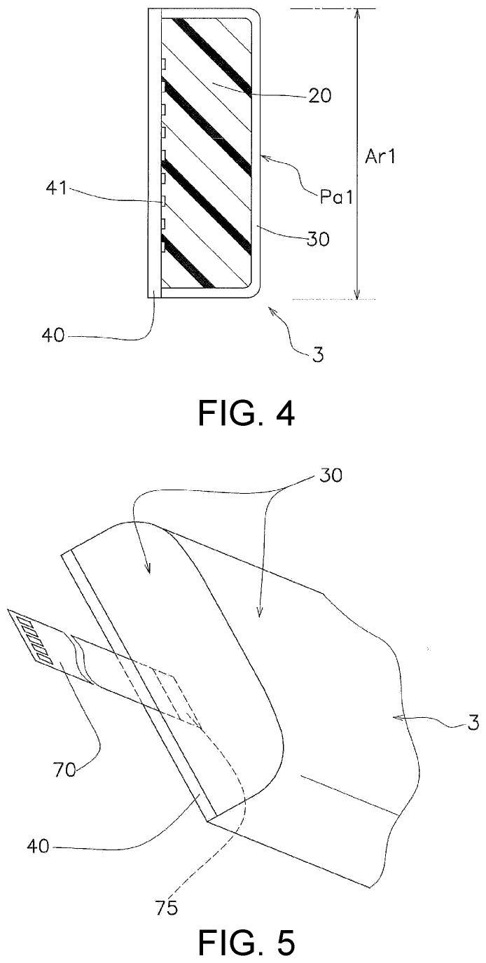

Further, the molded body 20 made of the hot melt adhesive shown in FIG. 2 extends to insides of the tip 3 and the hinge 4. FIG. 4 shows a cross-section of a portion of the tip 3 along line II-II in FIG. 1. The molded body 20 in the portion of the tip 3 shown in FIG. 4 is also made of the hot melt adhesive. A wiring 41 is formed on the circuit film 40 in the portion of the tip 3. Also in the portion of the tip 3, the protective film 30 has the contact area Ar1 disposed on the entire surface of the contact portion Pa1. The molded body 20 in the portion of the tip 3 is also the hot melt adhesive disposed on a side opposite to the skin with the contact area Ar1 of the protective film 30 interposed therebetween. The hot melt adhesive (molded body 20) constituting the portion of the tip 3 shown in FIG. 4 has a three-dimensional shape having a substantially rectangular cross-section smaller than the cross-sectional shape shown in FIG. 2. As described above, the molded body 20 constitutes a prescribed three-dimensional shape inside the molded article 10 excluding its surfaces.

The hot melt adhesive covers a part of the circuit film 40. In particular, the wiring 41 connected to the integrated circuit 60 is covered with the hot melt adhesive. The integrated circuit 60 can also be regarded as a constituent element of the electric circuit 50. In a case in which the integrated circuit 60 has a lead wire, the wiring 41 is, for example, a metal terminal connected to the lead wire. Since the lead wire of the integrated circuit 60 and the metal terminal of the circuit film 40 are rusted by moisture, the lead wire and the metal terminal covered with the hot melt adhesive have improved waterproofness and prevent problems such as rusting. In particular, since the hot melt adhesive has excellent adhesiveness to a metal, a gap is not easily formed between the hot melt adhesive and the metal. In this way, the molded body 20 can define small and complicated shapes of the portions of the temple 2, the tip 3, and the hinge 4 of the spectacles 1 while being integrated with the circuit film 40 and covering a part thereof. In the first embodiment, the electric circuit 50 is also covered with the hot melt adhesive.

The hot melt adhesive feels tacky to the user when touched by the user. Here, tackiness is a property of causing a sticky sensation to a person who touches it. The contact area Ar 1 of the protective film 30 covers a surface of the hot melt adhesive disposed on the contact portion Pa1. For that reason, the user who uses the spectacles 1 does not feel the tackiness peculiar to the hot melt adhesive and can obtain a comfortable wearing feeling.

In the molded article 10 shown in FIGS. 2 to 4, only the protective film 30 has the contact area Ar1. In other words, in the first embodiment, the circuit film 40 does not have a contact area.

The integrated circuit 60 and an external device, a power supply, or the like can be connected by, for example, a flexible circuit board 70 shown in FIG. 5. The flexible circuit board 70 is disposed, for example, at a tip portion of the tip 3. The flexible circuit board 70 and the wiring 41 of the circuit film 40 are connected by, for example, an anisotropic conductive film 75. Here, the flexible circuit board 70 is used to connect the circuit film 40 to an external electric device. However, wiring members other than the flexible circuit board 70, such as a flat cable, can also be used.

### (2) DETAILED CONFIGURATION

### (2-1) Molded Body 20

The molded body 20 is formed by molding a hot melt adhesive into a three-dimensional shape. The molded body 20 may be transparent, translucent, or opaque. The hot melt adhesive is molded into a prescribed shape using, for example, a transfer molding method. For that reason, the hot melt adhesive is preferably a one-liquid thermoplastic hot melt adhesive. Further, the hot melt adhesive is preferably a material that can be injection-molded in a low temperature and low pressure condition of an injection pressure of 0.2 to 6 MPa and an injection temperature of 180° C. or higher and 240° C. or lower. The molded body 20 is formed by setting, for example, a decorative film or transfer sheet for forming the protective film 30 and the circuit film 40 in a mold. A molten hot melt adhesive is injected into a cavity in which the decorative film or transfer sheet and the circuit film 40 are set to be cooled and solidified, and thus the molded body 20 is molded. The injection molding condition at this time is preferably selected from low temperature and low pressure conditions in the range of the injection pressure of 0.2 to 6 MPa and the injection temperature of 180° C. or higher and 240° C. or lower. Even by such low temperature and low pressure injection molding, it is possible to perform transfer to the hot melt adhesive using the transfer sheet.

Such a hot melt adhesive includes Technomelt (registered trademark) manufactured by Henkel Japan Ltd. Examples of the hot melt adhesive include a polyamide-based hot melt adhesive, a polyolefin-based hot melt adhesive, and a polyurethane-based hot melt adhesive. For example, the polyamide-based hot melt adhesive includes Technomelt PA, the polyolefin-based hot melt adhesive includes Technomelt AS, and the polyurethane-based hot melt adhesive includes Technomelt PUR. In the case of indicating such hot melt adhesives with model numbers of Technomelt, they are, for example, 6208, 6208S, 633, 638, 652, 657, 673, 678, 341, 648, 2384, 2384S, or AS-5375.

In the molded body 20, the thinnest portion of the hot melt adhesive is preferably 0.2 mm or more. For example, a reinforcing agent such as glass fibers or an inorganic filler can be added to the molded body 20.

### (2-2) Protective Film 30

The protective film 30 is a decorative film or a transfer layer. In a case in which the protective film 30 is a decorative film, the decorative film includes, for example, a base film, a pattern layer, and an adhesive layer. In the protective film 30 shown here, the base film, the pattern layer, and the adhesive layer form a layered structure, and the base film is disposed on the outermost portion of the molded article 10. The pattern layer is disposed on a side closer to the molded body 20 than the base film. The adhesive layer is disposed between the pattern layer and the molded body 20. In short, the base film, the pattern layer, and the adhesive layer are disposed in order from an outer side of the molded article 10 toward the molded body 20. Also, the pattern layer may be partially or completely omitted. Further, a coat layer may be provided on an outer side of the base film in order to enhance durability. A thickness of the base film is generally selected from the range of, for example, 10 μm to 500 μm. The thickness of the base film is preferably 15 μm to 100 μm in order to easily follow the three-dimensional shape of the molded body 20. Also, the pattern layer, the base film, and the adhesive layer may be formed from the outer side of the molded article 10 toward the molded body 20. A coat layer may be provided on an outer side of the pattern layer. In addition, the base film may also serve as an adhesive layer.

For the base film, for example, at least one of a resin and an elastomer is used. The resin base film is selected from, for example, a resin film made of a polyester resin, a polyethylene terephthalate (PET) resin, an acrylic resin, a polycarbonate resin, a polybutylene terephthalate (PBT) resin, a triacetyl cellulose resin, a styrene resin, or an ABS resin, a multilayer film of an acrylic resin and an ABS resin, or a multilayer film of an acrylic resin and a polycarbonate resin. Further, for the elastomer used for the base film, for example, a thermoplastic elastomer (TPE) can be used. Examples of the thermoplastic elastomer include an amide-based TPE (TPA), an ester-based TPE (TPC), an olefin-based TPE (TPO), a styrene-based TPE (TPS), and a urethane-based TPE (TPU). Also, a base film in which a resin film and an elastomer film are laminated may be used.

The pattern layer is a layer for expressing a design such as a pattern. The pattern layer is formed on the base film using, for example, a gravure printing method or a screen printing method. A material constituting the pattern layer includes, for example, a resin such as an acrylic resin, a vinyl chloride vinyl acetate copolymer resin, a thermoplastic urethane-based resin, or a polyester-based resin, and a pigment or dye added to the resin. Also, the pattern layer may be one to which a metallic style design is applied by using, for example, a printing method or a metal vapor deposition method. In the printing method, for example, aluminum paste or mirror ink can be used. Further, in the metal vapor deposition method, a metal material such as aluminum, tin, indium, or chromium can be used. Also, a coat layer for protecting the pattern layer may be provided on the pattern layer on a side opposite to the base film.

For the adhesive layer, for example, a thermoplastic resin can be used. Examples of the thermoplastic resin used for the adhesive layer include a urethane-based resin, a polyester-based resin, a polyamide-based resin, an acrylic resin, and a vinyl chloride vinyl acetate copolymer resin. The adhesive layer develops adhesiveness due to heat of a molten resin and improves an adhesive force with respect to the molded body 20. A thickness of the adhesive layer is, for example, 2 μm to 20 μm in terms of a film thickness after drying. In a case in which an adhesive force developed by the hot melt adhesive is sufficient for adhesion of the decorative film, the adhesive layer may be omitted.

In a case in which the protective film 30 is configured of a transfer layer, a transfer sheet is placed in a mold to form the transfer layer at the same time as molding. The transfer sheet includes, for example, a substrate sheet, a transfer layer, and an adhesive layer. By transfer, the transfer layer and the adhesive layer are transferred from the substrate sheet to the surface of the molded body 20 and form the protective film 30 that protects the surface of the molded body 20.

The substrate sheet is made of, for example, a polyolefin-based resin, a polycarbonate-based resin, a polyethylene terephthalate-based resin, or a special multilayer structure film.

The transfer layer includes, for example, a pattern layer, and a peeling layer for peeling the transfer layer from the substrate sheet. The peeling layer may be configured to function as a coat layer that protects the pattern layer. Also, a coat layer may be provided separately from the peeling layer. For the pattern layer of the transfer layer, the same pattern layer as that of the decorative film can be used.

For the adhesive layer for adhesion of the transfer layer, the same adhesive layer as that for the decorative film can be used.

### (2-3) Circuit Film 40

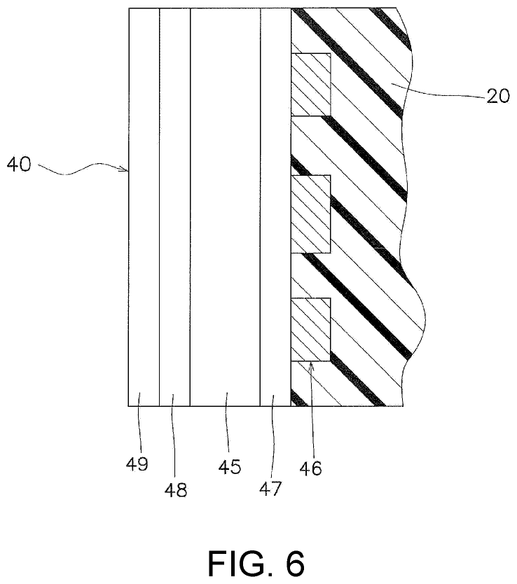

As shown in FIG. 6, the circuit film 40 includes, for example, a thermoplastic insulating film 45, the conductive layer 46, pattern layers 47 and 48, and a coat layer 49.

For the thermoplastic insulating film 45, for example, a film made of a thermoplastic resin, a film made of a thermoplastic elastomer, or a laminated film thereof can be used. Examples of the thermoplastic resin film include a resin film made of a polyester resin, a polyethylene terephthalate (PET) resin, an acrylic resin, a polycarbonate resin, a polybutylene terephthalate (PBT) resin, a triacetyl cellulose resin, a polyimide resin, a polyethylene naphthalate (PEN) resin, a liquid crystal polymer (LCP) resin, a cycloolefin polymer (COP), a styrene resin, or an ABS resin, a multilayer film of an acrylic resin and an ABS resin, and a multilayer film of an acrylic resin and a polycarbonate resin. Further, for the elastomer used for the base film, for example, a thermoplastic elastomer (TPE) can be used. Thermoplastic elastomers include, for example, TPA, TPC, TPO, TPS, and TPU. A thickness of the insulating film 45 is selected, for example, from the range of 30 μm to 500 μm.

The conductive layer 46 is formed, for example, by forming a conductive material on a surface of the insulating film 45 and/or the pattern layer 47 and then patterning the conductive layer 46. Alternatively, the conductive layer 46 is formed, for example, by printing a conductive ink on the surface of the insulating film 45 and/or the pattern layer 47 by thick film printing. Examples of the conductive material constituting the conductive layer 46 include a metal material and a semiconductor material. For the metal material, for example, copper, aluminum, carbon, nickel, gold, silver, or tin can be used. The semiconductor material includes, for example, a metal oxide and a conductive polymer.

The pattern layers 47 and 48 are layers for expressing designs such as patterns. The pattern layers 47 and 48 are formed on the insulating film 45 using, for example, a gravure printing method or a screen printing method. Materials constituting the pattern layers 47 and 48 include, for example, resins such as acrylic resins, vinyl chloride vinyl acetate copolymer resins, thermoplastic urethane-based resins, and polyester-based resins, and pigments or dyes added to the resins. Also, the pattern layers 47 and 48 may be ones to which metallic style designs are applied using, for example, an insulating aluminum paste or a mirror ink. In addition, unevenness may be formed on the pattern layer 48. Also, although a case in which two pattern layers 47 and 48 are disposed is described here, a circuit film 40 in which one or both of the pattern layers 47 and 48 are not formed can also be used.

The coat layer 49 is, for example, a layer for improving durability of the circuit film 40. The coat layer 49 is made of a material that can adhere to the molded body 20 at the time of integral molding. For the coat layer 49, for example, an ultraviolet (UV) curable resin or a thermosetting resin is used. The circuit film 40 may also have a configuration in which the coat layer 49 is not provided.

### Second Embodiment

### (3) OVERALL CONFIGURATION

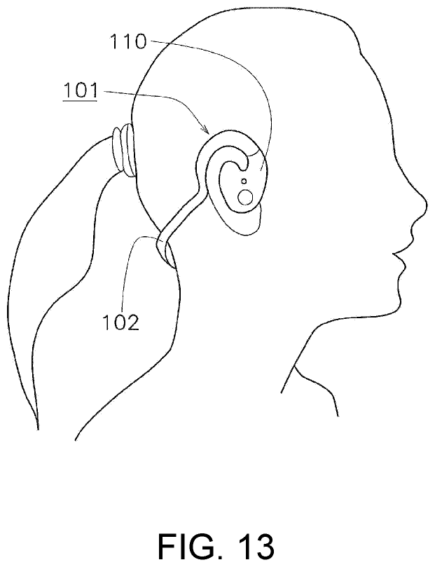

FIG. 13 shows a waterproof music player to which a wearable electric-circuit-integrated molded article according to a second embodiment of the present invention is applied. In a waterproof music player 101 shown in FIG. 13, two body portions 110 facing ears are wearable electric-circuit-integrated molded articles. The waterproof music player 101 has a hooking portion 102 in addition to the body portions 110. The hooking portion 102 is configured of portions that hang on the ears and a string portion that connects the two body portions 110 disposed on the left and right ears. For example, the body portions 110 and the hooking portion 102 are separately molded and adhere to each other after each molding.

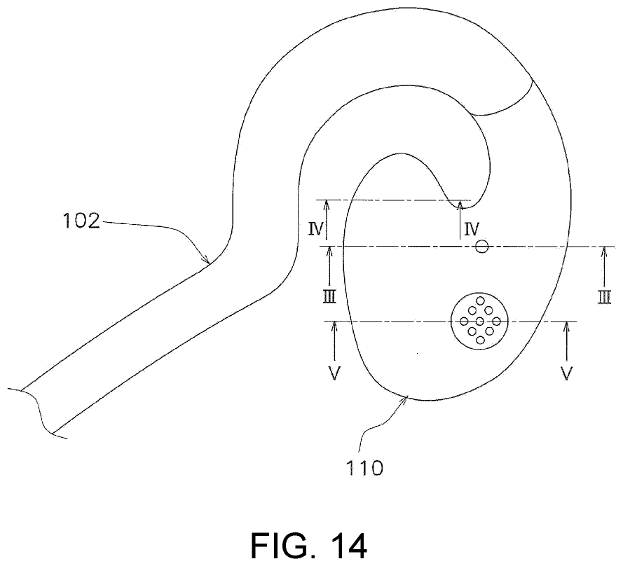

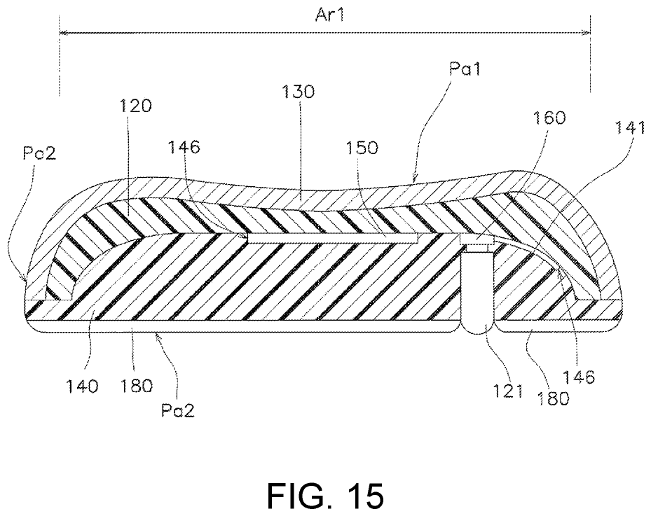

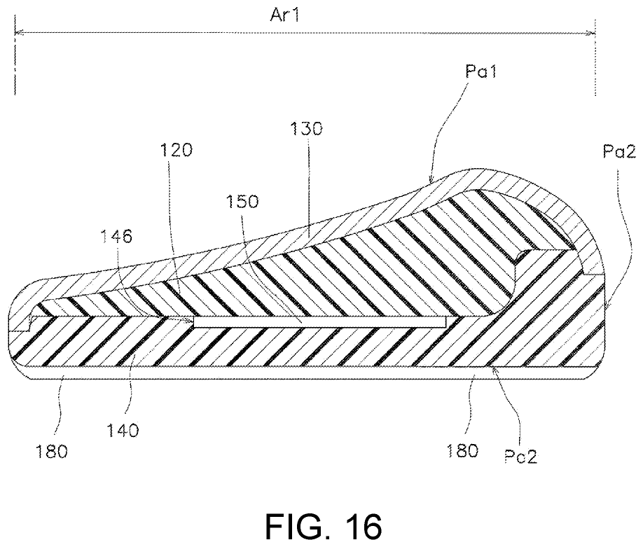

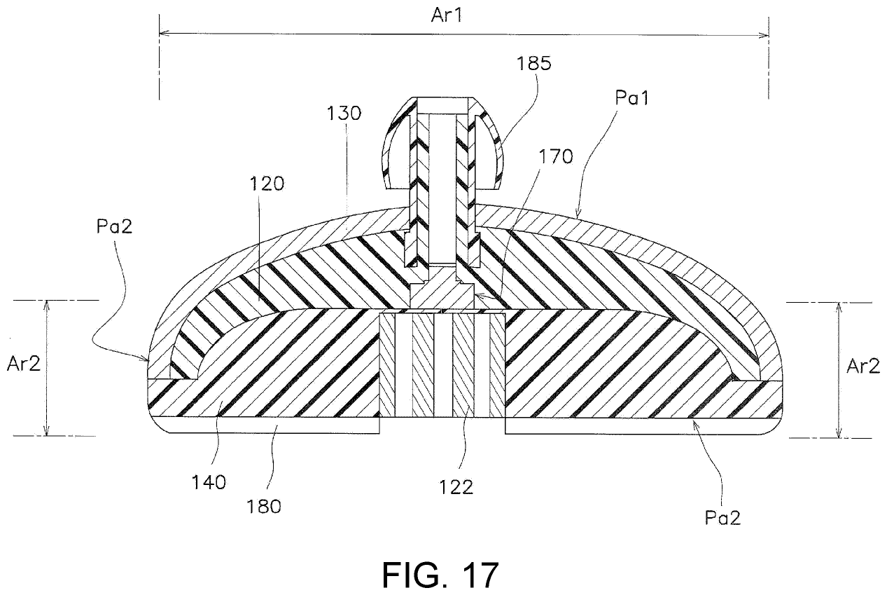

FIG. 14 shows an enlarged view of the body portion 110 of the waterproof music player 101 shown in FIG. 13. FIG. 15 shows a cross-section along line III-III in FIG. 14, FIG. 16 shows a cross-section along line IV-IV in FIG. 14, and FIG. 17 shows a cross-section along line V-V in FIG. 14. A contact portion Pa1 that comes into direct contact with skin of a human body is located on an inner surface of the body portion 110 facing a head portion of a user.

Portions on surfaces of the body portion 110 other than the contact portion Pa1 are portions that the user can touch by hand, for example, at the time of putting on or taking off the waterproof music player 101. However, since they are not locations that always come into contact with the skin, a location that the user can touch by hand other than the contact portion Pa1 is called a quasi-contact portion Pa2.

A three-dimensional shape of the body portion 110, which is the molded article, is mainly formed by a molded body 120 and a molded circuit component 140. For that reason, the molded body 120 is molded into a prescribed three-dimensional shape. In the second embodiment, a case in which the molded body 120 is made only of a hot melt adhesive will be described. For example, in a case in which devices such as an LED 160, a speaker 170, and an antenna 190 are mounted inside the body portion 110, by using the hot melt adhesive, a thickness of the thinnest portion of the molded body 120 can be reduced to, for example, about 0.4 mm. In the molded circuit component 140, a light guide path 121 for guiding light radiated from the LED 160 is made of a transparent resin. Further, a waveguide member 122 in which a through hole is formed is fitted into a rear portion of the speaker 170, which is also provided for decoration. The speaker 170 is covered with the molded body 120 including a portion (not shown) connected to the molded circuit component 140.

As shown in FIGS. 15 to 17, a protective film 130 covers a part of a surface of the molded body 120. In addition, as shown in FIGS. 15 to 17, the molded circuit component 140 is integrally molded with the molded body 20. The molded circuit component 140 has a conductive layer 146. An electric circuit 150 is provided in the conductive layer 146 of the molded circuit component 140.

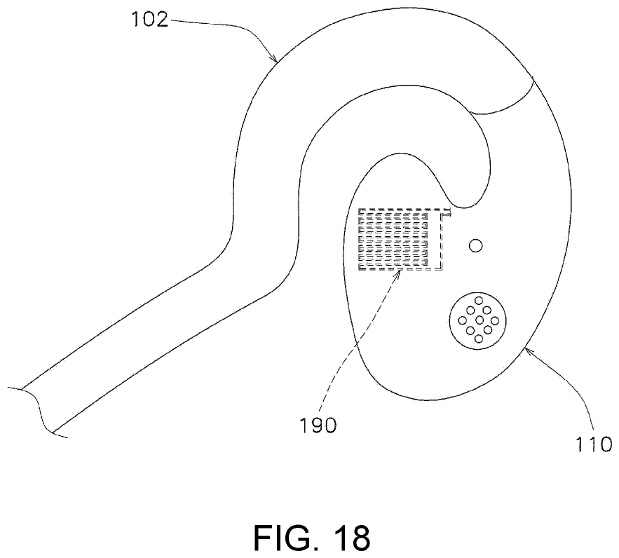

Also in the second embodiment, the electric circuit 150 includes the antenna 190 shown in FIG. 18. The antenna 190 (electric circuit 150) generates electromagnetic waves to the outside of the body portion 110. Further, the antenna 190 receives electromagnetic waves generated outside the body portion 110 and generates an electric signal. A coating film 180 is formed on an outer surface of the molded circuit component 140. The coating film 180 may be a coat layer for improving durability of the molded circuit component 140. Also, formation of the coating film 180 may be omitted.

Further, the hot melt adhesive which is the molded body 120 of the second embodiment covers a part of an earpiece 185 made of a soft elastomer which is fitted into an ear hole. Since the molded body 120 covering a part of the elastomer earpiece 185 is the hot melt adhesive, the soft earpiece 185 can be reliably fixed.

In the second embodiment, in the body portion 110, the protective film 130 has a contact area Ar1 disposed on the entire surface of the contact portion Pa1, for example, as shown in FIG. 15. The molded body 120 of the body portion 110 is the hot melt adhesive disposed on a side opposite to the skin with the contact area Ar1 of the protective film 130 interposed therebetween. The hot melt adhesive constituting the molded body 120 has a complicated three-dimensional shape formed to match unevenness of the ear. The shape of the hot melt adhesive (molded body 120) shown in FIGS. 15 to 17 defines the three-dimensional shape of the body portion 110 on a side on which it abuts the ear.

The hot melt adhesive covers a part of the molded circuit component 140. In particular, the hot melt adhesive covers a wiring 141 connected to the LED 160. The wiring 141 is formed, for example, by the conductive layer 146 of the molded circuit component 140. The LED 160 can be regarded as a constituent element of the electric circuit 150. In other words, the LED 160 is a device mounted on the body portion 110. The LED 160, which is a part of the electric circuit 150, causes a physical change of generating light toward the outside of the molded article 10. Here, the case in which the LED 160 is formed in the electric circuit 150 has been described, but for example, a photodiode may be provided in the electric circuit 150. The photodiode receives a change (physical change) of infrared rays generated outside the molded article 10 and generates an electric signal.

The above-mentioned metal wiring 141 is usually rusted by moisture. However, the wiring 141 covered with the hot melt adhesive has improved waterproofness and problems such as rusting is prevented. In particular, since the hot melt adhesive has excellent adhesiveness to a metal, a gap between the hot melt adhesive and the metal is not easily generated. In this way, the molded body 120 can define a small and complicated shape of the body portion 110 in accordance with a shape of the ear while being integrated with the molded circuit component 140 and covering a part thereof.

Also, a wiring (not shown) connected to the speaker 170 is covered with the hot melt adhesive. The wiring connected to the speaker 170 is formed, for example, by the conductive layer 146 of the molded circuit component 140. The speaker 170 can be regarded as a constituent element of the electric circuit 150. In other words, the speaker 170 is a device mounted on the body portion 110. The speaker 170, which is a part of the electric circuit 150, causes a physical change of generating sound toward the outside of the molded article 10. Here, the case in which the speaker 170 is formed in the electric circuit 150 has been described, but for example, a microphone may be provided in the electric circuit 150. The microphone receives a sound (physical change) generated outside the molded article 10 and generates an electric signal.

The hot melt adhesive makes the user feel tacky when touched by the user. The contact area Ar1 of the protective film 130 covers a surface of the hot melt adhesive disposed in the contact portion Pa1. For that reason, the user who uses the waterproof music player 101 does not feel tackiness peculiar to the hot melt adhesive and can obtain a comfortable wearing feeling.

In the body portion 110 shown in FIGS. 15 to 17, only the protective film 130 has the contact area Ar1. In other words, in the second embodiment, the molded circuit component 140 does not have a contact area.

The LED 160 and the speaker 170 can be connected to an external device or power supply by, for example, a cable (not shown). Alternatively, a power source that can be charged from the outside using electromagnetic waves may be provided in the body portion 110, so that the waterproof music player 101 may be configured to operate without being connected to an external device or power source by wire. Further, the body portion 110 may be configured to include an integrated circuit (not shown).

### (4) DETAILED CONFIGURATION

### (4-1) Molded Body 120

The molded body 120 of the second embodiment is obtained by molding the hot melt adhesive into the three-dimensional shape. The molded body 120 can be molded by the same molding method using the same material as the molded body 20 of the first embodiment. In a molding process of the molded body 120 of the second embodiment, the molded circuit component 140, the LED 160, and the speaker 170 after plating are set in the cavity of the mold in place of the circuit film 40 and the integrated circuit 60. The hot melt adhesive is injected by a transfer molding method into the cavity of the mold in which the molded circuit component 140, the LED 160 and the speaker 170 after the plating are set. A material of the hot melt adhesive and an injection condition can be set, for example, in the same manner as in the manufacturing method of the molded body 20 of the first embodiment.

### (4-2) Protective Film 130

The protective film 130 of the second embodiment is a decorative film or a transfer layer. Since the protective film 130 of the second embodiment can have the same configuration as the protective film 30 of the first embodiment, detailed description thereof will be omitted here.

### (4-3) Molded Circuit Component 140

The molded circuit component 140 is a component in which the conductive layer 146 is formed on a resin molded component. The conductive layer 146 can be formed on a surface of the resin molded component, for example, using a laser direct structuring (LDS) process. In the LDS process, for example, the surface of the resin molded component containing an inorganic filler is irradiated with an infrared laser to activate the inorganic filler. The portion in which the activated inorganic filler is disposed can be metal-coated by, for example, electroless plating. This metal-coated portion becomes the conductive layer 146.

The material of the molded circuit component 140 is a material that can be injection-molded. For the material of the molded circuit component 140, for example, a thermoplastic resin or a thermoplastic elastomer can be used. Examples of the thermoplastic resin include a polyester resin, a polyethylene terephthalate (PET) resin, an acrylic resin, a polycarbonate resin, a polybutylene terephthalate (PBT) resin, a triacetyl cellulose resin, a polyimide resin, a polyethylene naphthalate (PEN) resin, and a liquid crystal polymer (LCP) resin, a cycloolefin polymer (COP), a styrene resin, and an ABS resin. The thermoplastic elastomer includes, for example, TPA, TPC, TPO, TPS, and TPU.

Also, an integrated circuit may be mounted on the molded circuit component 140.

### (5) MODIFIED EXAMPLES

Although the first and second embodiments of the present invention have been described above, the present invention is not limited to the above-mentioned embodiments, and various modifications can be made without departing from the gist of the invention. In particular, a plurality of embodiments and modified examples described herein can be arbitrarily combined as needed.

### (5-1) First Modified Example

In the above-mentioned first embodiment, the case in which the molded body 20 is made only of the hot melt adhesive has been described. However, the molded body 20 may be formed in combination with a material other than the hot melt adhesive. The molded body 20 may be configured of, for example, a combination of a molded component made of a thermoplastic resin, a thermosetting resin, or a thermoplastic elastomer, and a three-dimensional portion made of a hot melt adhesive having a three-dimensional shape. Further, the molded component combined with the hot melt adhesive having a three-dimensional shape may be made of a material other than a resin, and may be, for example, a metal or ceramics.

In a case in which the molded body 20 is formed by combining the hot melt adhesive and the molded component in this way, the molded component does not have to have the conductive layer 146 as in the molded circuit component 140 of the second embodiment. Also, the number of molded components combined with the hot melt adhesive may be plural, and the molded article may be formed by combining the molded circuit component 140, a molded component other than the molded circuit component, and the hot melt adhesive.

In the case of combining the hot melt adhesive with a molded component other than the hot melt adhesive, for example, after setting the molded component, the circuit film 40, and the protective film 30 in the cavity of the mold, the molten hot melt adhesive is injected into the cavity to mold the molded article. Alternatively, in the case of combining the hot melt adhesive and a molded component other than the hot melt adhesive and other than the molded circuit component 140, for example, after setting the molded component, the molded circuit component 140, and the protective film 130 in the cavity of the mold, the molten hot melt adhesive is injected into the cavity to mold the molded article.

### (5-2) Second Modified Example

In the above-mentioned first embodiment and second embodiment, the molded article 10 and the body portion 110 applied to the spectacles 1 and the waterproof music player 101 have been described as examples of the molded articles. However, the wearable electric-circuit-integrated molded article is not limited to that applied to the spectacles 1 and the waterproof music player 101. The wearable electric-circuit-integrated molded article may be applied to, for example, a wearable sphygmomanometer, a wearable pulse rate monitor, and a wearable blood glucose meter, which are caused to come into contact with a human body.

### (5-3) Third Modified Example

In the above-mentioned first embodiment, the case in which the electric circuit 50 includes an antenna as a device has been described. However, the device included in the electric circuit 50 is not limited to the antenna. The device included in the electric circuit 50 may be, for example, at least one of an LED, a heater, and a touch sensor. In a case in which the device is an LED and the LED is covered with a hot melt adhesive, the hot melt adhesive may be transparent or translucent. Also, the protective film 30 and/or the circuit film 40 may also be transparent or translucent. Also, in a case in which a touch sensor is provided in the electric circuit 50, a transparent electrode may be used. The transparent electrode is made of, for example, a metal oxide, a transparent conductive polymer, or a transparent conductive ink. Examples of the metal oxide include an indium tin oxide (ITO) and an indium zinc oxide (IZO). Examples of the transparent conductive polymer include PEDOT/PSS (poly-3,4-ethylenedioxythiophene/polysulfone acid). Also, examples of the transparent conductive ink include those containing carbon nanotubes or silver nanofibers in a binder.

Further, in the second embodiment, the case in which the electric circuit 150 includes the LED 160, the speaker 170, and the antenna 190 as devices has been described. However, the devices included in the electric circuit 150 are not limited to the LED 160, the speaker 170, and the antenna 190. The devices included in the electric circuit 150 may be, for example, at least one of a photodiode, a microphone, a heater, and a touch sensor.

### (5-4) Fourth modified example

The molded article 10 of the above-mentioned first embodiment includes the integrated circuit 60 mounted on the circuit film 40. The electric circuit 50 including the antenna, which is a device, is disposed on the same surface as the surface on which the integrated circuit 60 is mounted. However, the antenna and the integrated circuit 60 may be disposed on a different surface of a plurality of surfaces of the molded body 20.

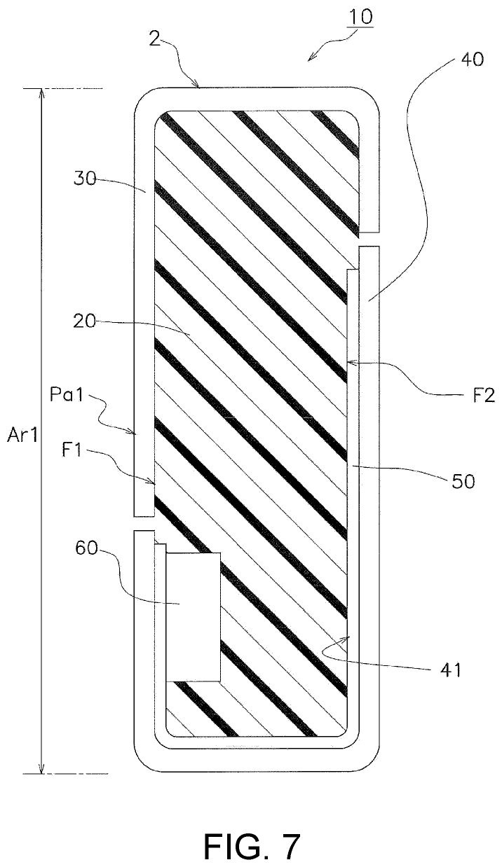

The circuit film 40 shown in FIG. 7 is formed to have a J-shaped cross-section on the surface of the molded body, which is a hot melt adhesive. The antennas of the integrated circuit 60 and the electric circuit 50 are disposed at different locations on the circuit film 40 having a J-shaped cross-section. Further, the integrated circuit 60 and the antenna which is a device are disposed on different surfaces of the molded body 20. The integrated circuit 60 and the antenna are covered with a hot melt adhesive. In other words, the different surfaces in this case are a first surface F1 and a second surface F2 facing each other in the molded body 20 of FIG. 7. Since electromagnetic waves are emitted from the antenna and electromagnetic waves are received by the antenna, the antenna is preferably disposed far from the head portion of the user, and the antenna is preferably disposed on the second surface F2 rather than on the first surface F1.

FIG. 7 shows a case in which the circuit film 40 is formed to have a J-shaped cross-section. However, the shape of the circuit film 40 for disposing the devices of the integrated circuit 60 and the electric circuit 50 on different surfaces of the molded body 20 may be another shape, for example, a U-shaped cross-section or an L-shaped cross-section.

In a case in which the shape of the circuit film 40 is an L-shaped cross-section, in order to dispose the integrated circuit 60 and the device on different surfaces of the molded body 20, the integrated circuit 60 and the electric circuit 50 (device) are disposed on surfaces adjacent to each other on which the circuit film 40 is disposed among the plurality of surfaces of the molded body 20.

### (5-5) Fifth Modified Example

In the above-mentioned first embodiment, the case in which the circuit film 40 is exposed from and disposed on the surface of the molded article 10 has been described. However, the circuit film 40 may be disposed not to be exposed from the surface of the molded article 10.

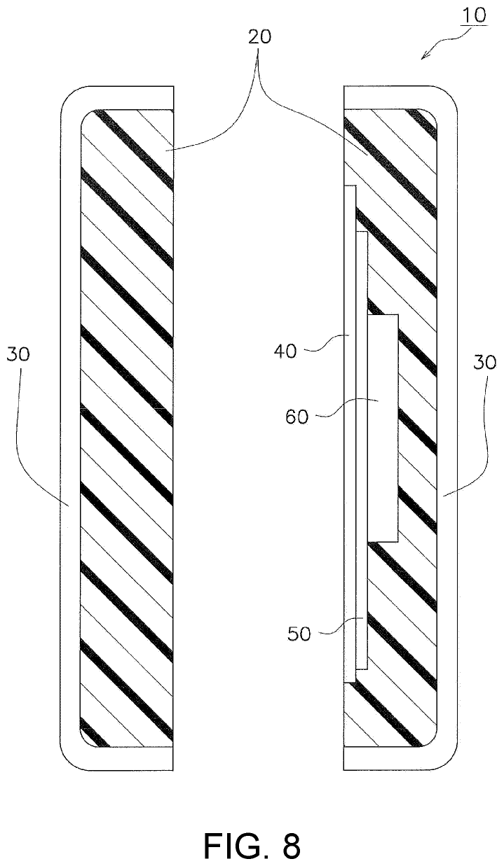

For example, as shown in FIG. 8, the molded body 20 is divided in half, and two components in which the protective film 30 is integrally molded on a portion corresponding to an outer periphery of the molded article 10 are first made. At the time of integral molding, the circuit film 40, the electric circuit 50, and the integrated circuit 60 are integrally molded with the molded body 20 to be embedded in the molded body 20 of one component. These two components are caused to adhere to each other, and the entire outer periphery of the molded article 10 is covered with the protective film 30. Thus, the circuit film 40 is embedded in the molded body 20, and the molded article 10 from which the circuit film 40 is not exposed is formed on the surface.

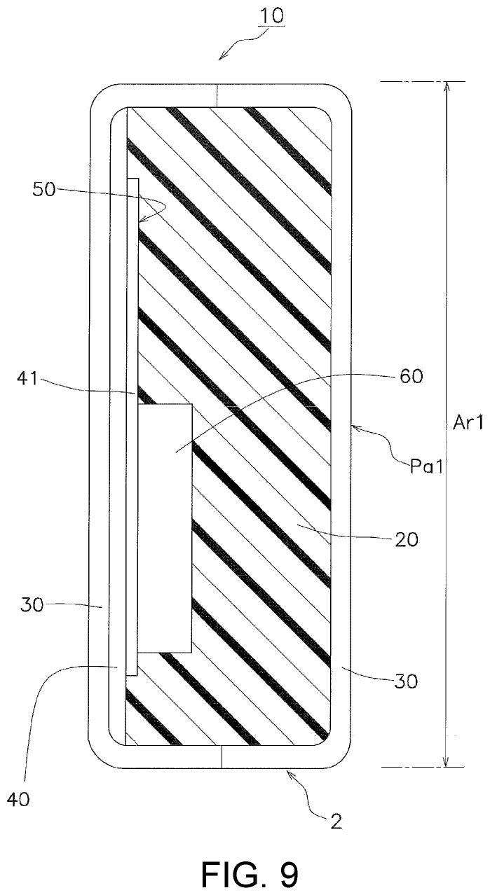

The location in which the circuit film 40 and the electric circuit 50 are embedded may be on the surface of the molded body 20 as shown in FIG. 9. By covering a further outer side of the circuit film 40 exposed from the surface of the molded body 20 with the protective film 30, the molded article 10 from which the circuit film 40 is not exposed can be formed on the surface of the molded article 10.

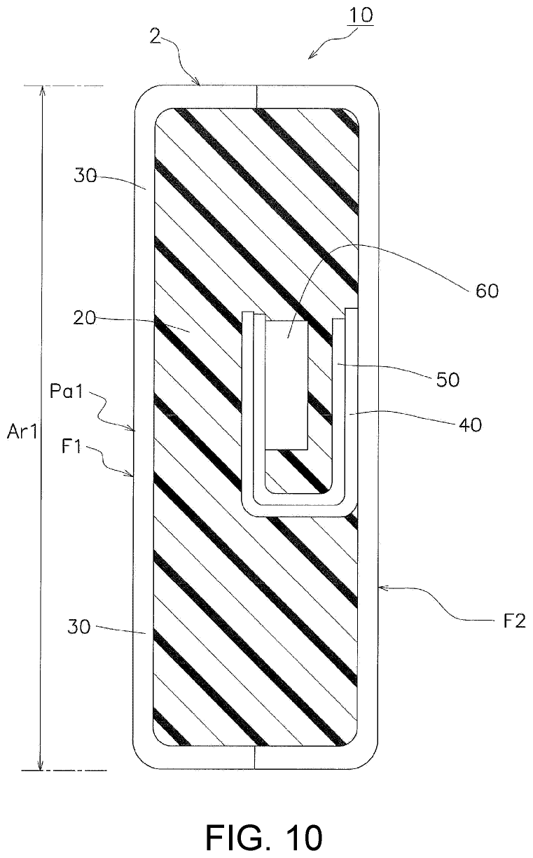

Further, as shown in FIG. 10, the circuit film 40 may be formed to have a U-shaped cross-section, and the protective film 30 may be configured to cover the entire circumference of outer peripheries of the circuit film 40, the electric circuit 50, and the molded body 20. In this case, as shown in FIG. 8, the molded body 20 divided into two can be formed by connecting them with an adhesive.

Further, in the above-mentioned second embodiment, the case in which the molded circuit component 140 is exposed from and disposed on the surface of the body portion 110 which is a molded article has been described. However, the molded circuit component 140 may be disposed not to be exposed from the surface of the molded article. For example, the molded circuit component may be configured to be embedded in a hot melt adhesive.

### (5-6) Sixth Modified Example

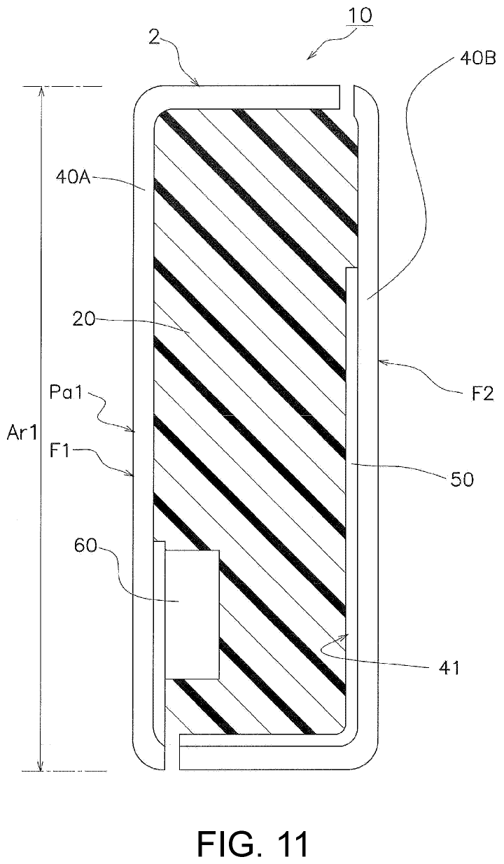

In the above-mentioned first embodiment, the case in which the protective film 30 has the contact area Ar1 has been described. However, the circuit film can also be configured to have a contact area. For example, the electric-circuit-integrated molded article 10 shown in FIG. 11 includes two circuit films 40A and 40B, and the circuit film 40A is provided with the contact area Ar1. In this case, one of the circuit films 40A is disposed on the first surface F1, and the integrated circuit 60 is mounted on the circuit film 40A. The other circuit film 40B is disposed on the second surface F2, and an antenna that is a part of the electric circuit 50 is disposed on the circuit film 40B. Also, the integrated circuit 60 and the electric circuit 50 may be connected inside the molded body 20 or may be connected outside the molded body 20.

### (5-7) Seventh Modified Example

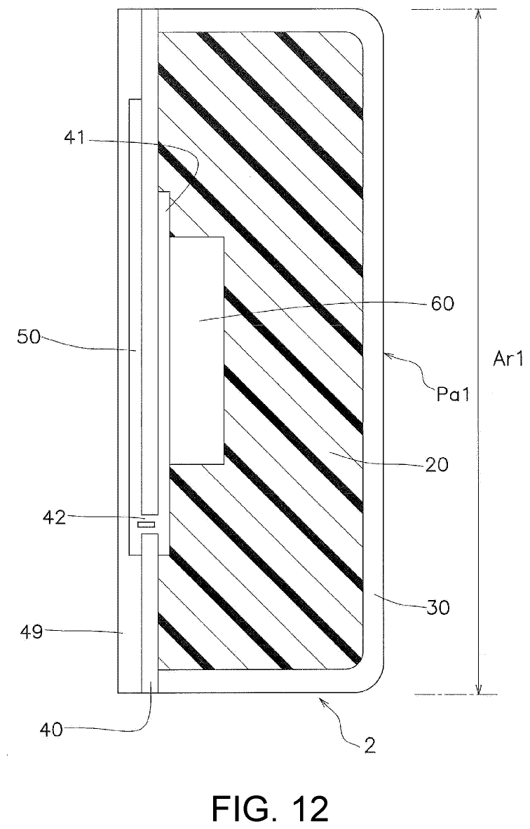

In the above-mentioned first embodiment, the case in which the circuit film 40 is provided with the conductive layer 46 on only one side has been described. However, conductive layers may be provided on both sides of the circuit film 40. In the circuit film 40 shown in FIG. 12, the wiring 41 and the antenna of the electric circuit 50 are connected by a through hole 42. The antenna is formed on a surface of two main surfaces of the circuit film 40 on a side opposite to a surface in contact with the molded body 20. The electric circuit 50 including the antenna is covered and protected by the coat layer 49.

### (6) FEATURES

### (6-1)

As described in the above embodiments and modified examples, in the wearable electric-circuit-integrated molded article 10 and the body portion 110 which is a circuit-integrated molded article, a part or all of the molded bodies 20 and 120 having prescribed three-dimensional shapes is defined by the three-dimensional shape of the hot melt adhesive. In the spectacles 1 shown in FIG. 1, the three-dimensional shapes of the temple 2, the tip 3, and the hinge 4 are the prescribed three-dimensional shape of the molded body 20. The shape of the portion corresponding to the ear among the three-dimensional shapes of the body portion 110 of the waterproof music player 101 shown in FIGS. 15 to 17 is mainly the prescribed three-dimensional shape of the molded body 120.

In the above-mentioned first embodiment and second embodiment, all of the prescribed shapes of the molded bodies 20 and 120 are defined by the three-dimensional shape of the hot melt adhesive. Further, as described in the first modified example, in a case in which the molded bodies 20 and 120 are configured of a molded component and a hot melt adhesive, a three-dimensional shape other than the molded component is defined by the hot melt adhesive.

The hot melt adhesives of the molded bodies 20 and 120 are disposed at least on the surface of the molded body 20 of the contact portion Pa1 (see FIGS. 2 and 15). The contact portion Pa1 is covered with the protective films 30, 130 or the contact area Ar1 of the circuit film 40A. If this contact portion Pa1 is not covered with the protective films 30 and 130 or the circuit film 40A, the hot melt adhesive will come into direct contact with the user's skin. The hot melt adhesive of the molded body 20 of the contact portion Pa1 is covered with the protective films 30 and 130 or the contact area Ar1 of the circuit film 40A, it is possible to prevent the hot melt adhesive from coming into direct contact with the skin, and to prevent problems caused by the hot melt adhesive coming into contact with the skin.

For example, a user of the spectacles 1 is given a tactile sensation of the protective film 30 or the circuit film 40A instead of a tactile sensation of the surface of the hot melt adhesive, and thus the user can comfortably wear the spectacles 1. For example, a user of the waterproof music player 101 is given a tactile sensation of the protective film 130 instead of a tactile sensation of the surface of the hot melt adhesive, and thus the user can comfortably wear the waterproof music player.

A part of the circuit films 40, 40A and 40B shown in FIGS. 2 and 7 to 12 is covered with a hot melt adhesive. Thus, waterproofness of the conductive layer of the circuit films 40, 40A, and 40B covered with the hot melt adhesive is improved. In particular, in a case in which the electric circuit 50 including the antenna, the LED, the heater, or the touch sensor is covered with the hot melt adhesive, waterproofness of the antenna, the LED, the heater or the touch sensor is improved.

A part of the molded circuit component 140 shown in FIGS. 15 to 17 is covered with a hot melt adhesive. Thus, waterproof property of the conductive layer 146 of the molded circuit component 140 covered with the hot melt adhesive is improved. In particular, in a case in which the electric circuit 150 including the LED 160, the speaker 170, the antenna 190, the photodiode, the heater or the touch sensor is covered with the hot melt adhesive, waterproofness of the LED, the antenna, the speaker, the heater, or the touch sensor is improved.

### (6-2)

As compared with the circuit films 40, 40A, and 40B having the conductive layer 46, the protective film 30 is likely to have high flexibility. For example, as shown in FIG. 2, in a case in which only the protective film 30 is configured to have the contact area Ar1, the protective film 30 having high flexibility may be formed along a surface shape of the molded body 20. For that reason, in the electric-circuit-integrated molded article 10, even if the contact portion Pa1 has a fine three-dimensional shape, the protective film 30 has high flexibility, and thus it becomes easy to form such a fine three-dimensional shape. If the protective film 30 can sufficiently cope with a fine three-dimensional shape, it becomes possible to provide an electric-circuit-integrated molded article 10 having an excellent design.

Further, the protective film 130 tends to have higher flexibility than the molded circuit component 140 having the conductive layer 146. For that reason, for example, as shown in FIGS. 15 to 17, in a case in which only the protective film 130 is configured to have the contact area Ar1, the protective film 130 having high flexibility may be formed along the surface shape of the molded body 120. For that reason, in the body portion 110, which is an electric-circuit-integrated molded article, even if the contact portion Pa1 has a fine three-dimensional shape, the protective film 130 has high flexibility, and thus it becomes easy to form such a fine three-dimensional shape. If the protective film 130 can sufficiently cope with a fine three-dimensional shape, it becomes possible to provide a body portion 110 having an excellent design.

### (6-3)

For example, the wearable electric-circuit-integrated molded article 10 shown in FIG. 7 includes the integrated circuit 60 mounted on the circuit film 40. The electric circuit 50 includes an antenna connected to the integrated circuit 60. The circuit film 40 is formed on the surface of the hot melt adhesive to have a J-shaped cross-section. The first surface F1 on which the integrated circuit 60 is disposed is close to the head portion of the user, and the other second surface F2 is located farther than the head portion. For that reason, the second surface F2 is more suitable than the first surface F1 for disposing the antenna. As described above, by disposing the antennas of the integrated circuit 60 and the electric circuit 50 on different surfaces of the molded body 20 with the circuit film 40 having a J-shaped cross-section, the antennas can be disposed at suitable positions.

Even in a case in which the circuit film 40 has a U-shaped cross-section or an L-shaped cross-section, the electric-circuit-integrated molded article 10 can obtain the same effect as in the case of the J-shaped cross-section.

### (6-4)

The hot melt adhesive that constitutes the molded articles 20 and 120 of the electric-circuit-integrated molded article 10 and the body portion 110 is made of the material that can be injection-molded in the low temperature and low pressure condition of the injection pressure of 0.2 to 6 MPa and the injection temperature of 180° C. or higher and 240° C. or lower.

The electric-circuit-integrated molded article 10 configured in this way can reduce the damage given by the hot melt adhesive to, for example, the integrated circuit 60 connected to the electric circuit 50. It is possible to prevent problems such as disconnection between the integrated circuit 60 and the wiring 41 due to the pressure received from the resin during injection molding. For example, in a case in which heat resistance of the integrated circuit 60 is low, it is possible to prevent the integrated circuit 60 from being destroyed by the temperature at the time of injection molding.

The body portion 110, which is an electric-circuit-integrated molded article configured in this way, can reduce the damage given by the hot melt adhesive to, for example, the LED 160 and the speaker 170 included in the electric circuit 150. It is possible to prevent problems such as disconnection between the LED 160 and the wiring 141 due to the pressure received from the resin during injection molding. For example, in a case in which heat resistance of the LED 160 is low, it is possible to prevent the LED 160 from being destroyed by the temperature at the time of injection molding.

### (6-5)

In the electric-circuit-integrated molded article 10 of FIGS. 2 and 7 to 12, at least one of the protective film 30 and the circuit films 40, 40A, and 40B covers all the exposed parts of the hot melt adhesive in the molded body 20. As a result, the hot melt adhesive is not exposed in the electric-circuit-integrated molded article 10 due to at least one of the protective film 30 and the circuit films 40, 40A, and 40B. For example, even if the user touches the quasi-contact portion Pa2 described with reference to the spectacles 1 of FIG. 1, the user does not touch the hot melt adhesive. In this way, it is possible to prevent the hot melt adhesive from coming into contact with a human body at the time of handling the molded article 10, and it is possible to prevent problems caused by the hot melt adhesive coming into contact with the human body.

In the body portion 110 of FIGS. 15 to 17, the protective film 130 covers all the parts of the molded body 120 from which the hot melt adhesive is exposed. As a result, the hot melt adhesive is not exposed on the body portion 110. For example, even if the user touches the quasi-contact portion Pa2 of the body portion 110 of FIG. 15, the user does not touch the hot melt adhesive. In this way, it is possible to prevent the hot melt adhesive from coming into contact with the human body at the time of handling the body portion 110, and it is possible to prevent problems caused by the hot melt adhesive coming into contact with the human body.

There are several grades of hot melt adhesives, and especially hot melt adhesives that have good adhesiveness to electronic components such as metal circuits have tackiness on its surface. In order to prevent the hot melt adhesive from coming into contact with the human body, it is necessary to provide a protective film on the surface of the hot melt adhesive in products that come into contact with the human body.

### REFERENCE SIGNS LIST

1 Spectacles

2 Temple

3 Tip

4 Hinge

10 Electric-circuit-integrated molded article

20, 120 Molded body

30, 130 Protective film

40, 40A, 40B Circuit film

46, 146 Conductive layer

50, 150 Electric circuit

101 Waterproof music player

110 Body portion (example of electric-circuit-integrated molded article)

1. A wearable electric-circuit-integrated molded article including a contact portion that comes into direct contact with skin of a human body, comprising:
a molded body molded into a prescribed three-dimensional shape;
a protective film that covers at least a part of a surface of the molded body;
at least one of a circuit film and a molded circuit component that is integrally molded with the molded body and includes a conductive layer; and
an electric circuit that is provided in the conductive layer and causes a physical change outside the molded article or generates an electric signal in accordance with a physical change outside the molded article,
wherein at least one of the protective film and the circuit film includes a contact area disposed on the entire surface of the contact portion,
the molded body is disposed on the back side of the contact area, and includes a hot melt adhesive formed according to a three-dimensional shape of the contact area, and
the hot melt adhesive covers at least a part of at least one of the circuit film and molded circuit component,
the wearable electric-circuit-integrated molded article further comprising an integrated circuit mounted on the circuit film,
wherein the electric circuit includes at least one device of an antenna, an LED, a heater and a touch sensor, which is connected to the integrated circuit,
the circuit film is formed on a surface of the hot melt adhesive to have a U-shaped cross-section, a J-shaped cross-section, or an L-shaped cross-section, and
the integrated circuit and the device are disposed at other locations on the circuit film on a different surface of the molded body and covered with the hot melt adhesive.

2. The wearable electric-circuit-integrated molded article according to claim 1, wherein only the protective film has the contact area.

3. (canceled)

4. The wearable electric-circuit-integrated molded article according to claim 1, wherein the hot melt adhesive is a material that can be injection-molded in a low temperature and low pressure condition of an injection pressure of 0.2 to 6 MPa and an injection temperature of 180° C. or higher and 240° C. or lower.

5. The wearable electric-circuit-integrated molded article according to claim 1, wherein at least one of the protective film and the circuit film covers all the exposed portions of the hot melt adhesive in the molded body.

6. The wearable electric-circuit-integrated molded article according to claim 1, wherein the protective film is a decorative film or a transfer layer.

7. The wearable electric-circuit-integrated molded article according to claim 2, wherein the hot melt adhesive is a material that can be injection-molded in a low temperature and low pressure condition of an injection pressure of 0.2 to 6 MPa and an injection temperature of 180° C. or higher and 240° C. or lower.

8. The wearable electric-circuit-integrated molded article according to claim 2, wherein at least one of the protective film and the circuit film covers all the exposed portions of the hot melt adhesive in the molded body.

9. The wearable electric-circuit-integrated molded article according to claim 2, wherein the protective film is a decorative film or a transfer layer.

10. The wearable electric-circuit-integrated molded article according to claim 4, wherein at least one of the protective film and the circuit film covers all the exposed portions of the hot melt adhesive in the molded body.

11. The wearable electric-circuit-integrated molded article according to claim 4, wherein the protective film is a decorative film or a transfer layer.

12. The wearable electric-circuit-integrated molded article according to claim 5, wherein the protective film is a decorative film or a transfer layer.

13. The wearable electric-circuit-integrated molded article according to claim 7, wherein at least one of the protective film and the circuit film covers all the exposed portions of the hot melt adhesive in the molded body.

14. The wearable electric-circuit-integrated molded article according to claim 7, wherein the protective film is a decorative film or a transfer layer.

15. The wearable electric-circuit-integrated molded article according to claim 8, wherein the protective film is a decorative film or a transfer layer.

16. The wearable electric-circuit-integrated molded article according to claim 10, wherein the protective film is a decorative film or a transfer layer.

17. The wearable electric-circuit-integrated molded article according to claim 13, wherein the protective film is a decorative film or a transfer layer.

18. A wearable electric-circuit-integrated molded article including a contact portion that comes into direct contact with skin of a human body, comprising:
a molded body molded into a prescribed three-dimensional shape;
a protective film that embedded in molded body and includes a conductive layer;
an electric circuit that is provided in the conductive layer and causes a physical change outside the molded article or generates an electric signal in accordance with a physical change outside the molded article, and
a protective film that covers an entire surface of the molded body;
wherein the protective film includes a contact area disposed on the entire surface of the contact portion,
the molded body is disposed on the back side of the contact area, and includes a hot melt adhesive formed according to a three-dimensional shape of the contact area,
the hot melt adhesive covers at least a part of the circuit film,
the wearable electric-circuit-integrated molded article further comprising an integrated circuit mounted on the circuit film,
wherein the electric circuit includes at least one device of an antenna, an LED, a heater and a touch sensor, which is connected to the integrated circuit,
the circuit film is formed to have a U-shaped cross-section, a J-shaped cross-section, or an L-shaped cross-section, and
the integrated circuit and the device are disposed at other locations on the circuit film on a different surface of the molded body and covered with the hot melt adhesive.

19. The wearable electric-circuit-integrated molded article according to claim 18, wherein the hot melt adhesive is a material that can be injection-molded in a low temperature and low pressure condition of an injection pressure of 0.2 to 6 MPa and an injection temperature of 180° C. or higher and 240° C. or lower.

20. The wearable electric-circuit-integrated molded article according to claim 18, wherein the protective film is a decorative film or a transfer layer.
